(19) United States
(12) Patent Application Publication
(10) Pub. No.: US 2026/0049875 A1
(43) Pub. Date: Feb. 19, 2026

(54) METHOD AND APPARATUS FOR HYDROGEN AND TEMPERATURE COMPOSITE MONITORING OF BATTERY ENERGY STORAGE POWER STATION

(71) Applicant: HUANENG CLEAN ENERGY RESEARCH INSTITUTE, Beijing (CN)

(72) Inventors: Xiaofan Ping, Beijing (CN); Mingyi Liu, Beijing (CN); Xi Cao, Beijing (CN); Chuanzhao Cao, Beijing (CN); Haodong Lei, Beijing (CN); Zhouting Sun, Beijing (CN); Qian Cheng, Beijing (CN); Chaoran Yang, Beijing (CN)

(21) Appl. No.: 19/104,285

(22) PCT Filed: Feb. 2, 2024
(86) PCT No.: PCT/CN2024/075553

§ 371 Date: Feb. 17, 2025

(30) Foreign Application Priority Data
Feb. 2, 2023 (CN) 202310052588.4

(51) Int. Cl. G01K 11/324; G01K 1/02; G01K 3/00; H01M 10/48

(52) U.S. Cl. CPC G01K 11/324; G01K 1/026; G01K 3/005; H01M 10/486; H01M 2220/10

(57) ABSTRACT

A method for composite monitoring on hydrogen and a temperature of a battery energy storage power station includes: obtaining a first temperature and a second temperature of at least one monitoring point in each monitoring unit based on a group of optical fibers deployed on a battery surface in the monitoring unit, in which the group of optical fibers at least includes a first optical fiber configured to measure the first temperature of a battery body, and a second optical fiber coated with a hydrogen sensitive material configured to measure the second temperature of a battery exterior; and determining a hydrogen concentration of each monitoring point respectively based on a difference between the first temperature and the second temperature corresponding to the monitoring point.

### CROSS-REFERENCE TO RELATED APPLICATIONS

This application is based upon and claims priority to Chinese Patent Application No. 2023100525884, filed with the State Intellectual Property Office of P.R. China on Feb. 2, 2023, the entire contents of which are incorporated herein by reference.

### TECHNICAL FIELD

The disclosure relates to a field of risk control, and particularly to a method and an apparatus for composite monitoring on hydrogen and temperature of a battery energy storage power station, an electronic device, a computer readable storage medium, a computer program product, and a computer program.

### BACKGROUND

Under the background of a “double carbon” target strategy, a lithium-ion battery is widely used in an energy storage system because of multiple advantages such as, a high energy density and power density, a high energy conversion efficiency, a long cycle life and an environmental friendliness. However, with the aging of the battery, the thermal runaway of the lithium-ion battery may occur, which may cause a sharp rise in temperature and release a large amount of hydrogen, and even cause a safety accident. Therefore, a safe and reliable monitoring method on hydrogen and temperature is urgently required, to ensure a safe and stable operation of a battery energy storage power station.

### SUMMARY

Embodiments of the disclosure also provide a method and an apparatus for composite monitoring on hydrogen and temperature of a battery energy storage power station, an electronic device, a computer readable storage medium, a computer program product, and a computer program. The detailed solution includes the following.

An aspect of embodiments of the disclosure provides a method for composite monitoring on hydrogen and a temperature of a battery energy storage power station. The method includes:
obtaining a first temperature and a second temperature of at least one monitoring point in each monitoring unit based on a group of optical fibers deployed on a battery surface in the monitoring unit, in which the group of optical fibers at least includes a first optical fiber configured to measure the first temperature of a battery body, and a second optical fiber coated with a hydrogen sensitive material configured to measure the second temperature of a battery exterior; and
determining a hydrogen concentration of each monitoring point respectively based on a difference between the first temperature and the second temperature corresponding to the monitoring point, in which temperature increments of the second optical fiber at different hydrogen concentrations are pre-tested, a correlation function between the hydrogen concentration and the temperature increment is established by fitting the temperature increments of the second optical fiber at different hydrogen concentrations, and the hydrogen concentration at each monitoring point is determined based on the difference between the first temperature and the second temperature corresponding to each monitoring point and the correlation function;
obtaining the first temperature and the second temperature of the at least one monitoring point in each monitoring unit based on the group of optical fibers deployed on the battery surface in the monitoring unit includes:
controlling a laser corresponding to the group of optical fibers to emit a laser light at a preset time interval;
determining a target backscattered light corresponding to each monitoring point in the first optical fiber and the second optical fiber based on a time difference between a receiving time of each reference backscattered light and an emitting time of the laser light, in which the reference backscattered light is a backscattered light generated by the laser at each position in the first fiber and the second fiber; and
determining the first temperature and the second temperature of each monitoring point respectively based on intensities of a Stokes light and an anti-Stokes light in the target backscattered light corresponding to each monitoring point in the first optical fiber and the second optical fiber;
determining the target backscattered light corresponding to each monitoring point in the first optical fiber and the second optical fiber based on the time difference between the receiving time of each reference backscattered light and the emitting time of the laser light includes:
determining a position where Raman scattering occurs, corresponding to each reference backscattered light in the first optical fiber based on the time difference between the receiving time of each reference backscattered light in the first optical fiber and the emitting time of the laser light and a propagation speed of the laser in the first optical fiber, and determining the target backscattered light corresponding to each monitoring point in the first optical fiber by matching the position of each monitoring point with the position where the Raman scattering occurs corresponding to each reference backscattered light in the first optical fiber;
determining the first temperature of each monitoring point respectively based on the intensity of the Stokes light and the anti-Stokes light in the target backscattered light corresponding to each monitoring point in the first optical fiber and the second optical fiber includes:
determining a scattering position corresponding to each reference backscattered light based on the time difference between the receiving time of each reference backscattered light in the first optical fiber and the emitting time of the laser light, determining a first temperature of the scattering position corresponding to each reference backscattered light in the first optical fiber respectively based on the intensity of the Stokes light and the intensity of the anti-Stokes light in each reference backscattered light, and determining an average value of the first temperature at each scattering position within a monitoring interval corresponding to each monitoring point as the first temperature of each monitoring point.

Another aspect of embodiments of the disclosure provides an apparatus for composite monitoring on hydrogen and a temperature of a battery energy storage power station. The apparatus is applied to a server, and includes:
an obtaining module, configured to obtain a first temperature and a second temperature of at least one monitoring point in each monitoring unit based on a group of optical fibers deployed on a battery surface in the monitoring unit, in which the group of optical fibers at least includes a first optical fiber configured to measure the first temperature of a battery body, and a second optical fiber coated with a hydrogen sensitive material configured to measure the second temperature of a battery exterior; and
a determining module, configured to determine a hydrogen concentration of each monitoring point respectively based on a difference between the first temperature and the second temperature corresponding to the monitoring point, in which temperature increments of the second optical fiber at different hydrogen concentrations are pre-tested, a correlation function between the hydrogen concentration and the temperature increment is established by fitting the temperature increments of the second optical fiber at different hydrogen concentrations, and the hydrogen concentration at each monitoring point is determined based on the difference between the first temperature and the second temperature corresponding to each monitoring point and the correlation function.

The obtaining module is configured to:
control a laser corresponding to the group of optical fibers to emit a laser light at a preset time interval;
determine a target backscattered light corresponding to each monitoring point in the first optical fiber and the second optical fiber based on a time difference between a receiving time of each reference backscattered light and an emitting time of the laser light, in which the reference backscattered light is a backscattered light generated by the laser at each position in the first fiber and the second fiber; and
determine the first temperature and the second temperature of each monitoring point respectively based on intensities of a Stokes light and an anti-Stokes light in the target backscattered light corresponding to each monitoring point in the first optical fiber and the second optical fiber.

Determining the target backscattered light corresponding to each monitoring point in the first optical fiber and the second optical fiber based on the time difference between the receiving time of each reference backscattered light and the emitting time of the laser light includes:
determining a position where Raman scattering occurs, corresponding to each reference backscattered light in the first optical fiber based on the time difference between the receiving time of each reference backscattered light in the first optical fiber and the emitting time of the laser light and a propagation speed of the laser in the first optical fiber, and determining the target backscattered light corresponding to each monitoring point in the first optical fiber by matching the position of each monitoring point with the position where the Raman scattering occurs, corresponding to each reference backscattered light in the first optical fiber.

Determining the first temperature of each monitoring point respectively based on the intensity of the Stokes light and the intensity of the anti-Stokes light in the target backscattered light corresponding to each monitoring point in the first optical fiber and the second optical fiber includes:
determining a scattering position corresponding to each reference backscattered light based on the time difference between the receiving time of each reference backscattered light in the first optical fiber and the emitting time of the laser light, determining a first temperature of the scattering position corresponding to each reference backscattered light in the first optical fiber respectively based on the intensity of the Stokes light and the intensity of the anti-Stokes light in each reference backscattered light, and determining an average value of the first temperature at each scattering position within a monitoring interval corresponding to each monitoring point as the first temperature of each monitoring point.

Another aspect of embodiments of the disclosure provides a computer device, including a processor and a memory storing program codes executable by the processor.

The processor is configured to read the program codes to run a program corresponding to the program codes, to implement the method in the first aspect of the embodiments of the disclosure above.

Another aspect of embodiments of the disclosure provides a computer-readable storage medium for storing a computer program. The computer program is executed by a processor, to implement the method in the first aspect of the embodiments of the disclosure above.

Another aspect of embodiments of the disclosure provides a computer program product including computer instructions and storing a computer program. The computer program is executed by a processor to implement the method in the first aspect of the embodiments of the disclosure above.

Another aspect of embodiments of the disclosure provides a computer program including computer program codes. When the computer program codes are run on a computer, the computer is enabled to implement the method in the first aspect of the embodiments of the disclosure above.

Additional aspect and advantages of embodiments of the disclosure may be set forth in part in the description, and a part will be obvious from the description which follows, or may be learned by practice of the disclosure.

### BRIEF DESCRIPTION OF THE DRAWINGS

The above and/or additional aspects and advantages of embodiments of the disclosure will be apparent and easily understood from the following description of embodiments taken in combination with the accompanying drawings, in which:

FIG. 1 is a flow chart illustrating a method for composite monitoring on hydrogen and a temperature of a battery energy storage power station according to an embodiment of the disclosure;

FIG. 2 is a schematic diagram illustrating an optical fiber deployment according to an embodiment of the disclosure;

FIG. 3 is a schematic diagram illustrating an optical fiber deployment according to another embodiment of the disclosure;

FIG. 4 is a schematic diagram illustrating an optical fiber deployment according to another embodiment of the disclosure;

FIG. 5 is a flow chart illustrating a method for composite monitoring on hydrogen and a temperature of a battery energy storage power station according to another embodiment of the disclosure;

FIG. 6 is a flow chart illustrating a method for composite monitoring on hydrogen and a temperature of a battery energy storage power station according to another embodiment of the disclosure; and

FIG. 7 is a block diagram illustrating an apparatus for composite monitoring on hydrogen and a temperature of a battery energy storage power station according to an embodiment of the disclosure.

### DETAILED DESCRIPTION

Description will be made in detail below to embodiments of the disclosure, examples of which are illustrated in the accompanying drawings, in which the same or similar reference numerals indicate the same or similar elements or elements having the same or similar functions throughout. Embodiments described below with reference to the accompanying drawings are exemplary and are intended to explain embodiments of the disclosure, but not to be construed as a limitation of embodiments of the disclosure.

In a battery energy storage power station, a sensor based on electrochemistry and electricity are usually employed to monitor hydrogen and temperature. However, this type of sensor has a slow response velocity and a short service life, which causing a high cost and a poor timeliness of hydrogen and temperature monitoring. In addition, monitoring the hydrogen and temperature by a single device may only make the monitoring of the hydrogen and temperature reach an environmental level, thus the temperature of each battery and the hydrogen generated when the battery heat is out of control may not be detected timely and accurately. However, in the energy storage system with a large number of batteries, there is an expensive cost and a difficult communication when cell-level detection is realized by arranging a single sensor.

In embodiments of the disclosure, obtaining a first temperature and a second temperature of at least one monitoring point in each monitoring unit are obtained respectively based on a first fiber and a second fiber deployed on a battery surface in the monitoring unit, and a hydrogen concentration of each monitoring point is determined respectively based on a difference between the first temperature and the second temperature corresponding to each monitoring point,

Description is made below to a method for composite monitoring on hydrogen and temperature of a battery energy storage power station with reference to embodiments of the disclosure.

FIG. 1 is a flow chart illustrating a method for composite monitoring on hydrogen and a temperature of a battery energy storage power station according to an embodiment of the disclosure.

The method for composite monitoring on the hydrogen and temperature of the battery energy storage power station in embodiments of the disclosure is executed by an apparatus for composite monitoring on the hydrogen and the temperature of the battery energy storage power station (hereinafter referred to as monitoring apparatus) according to embodiments of the disclosure. The monitoring apparatus may be configured in a computer device or a terminal, to realize the composite monitoring on the hydrogen and the temperature of the battery energy storage power station and to improve the accuracy and timeliness of the hydrogen and temperature.

As illustrated in FIG. 1, the method for composite monitoring on the hydrogen and temperature of the battery energy storage power station includes actions at blocks 101 to 102.

At block 101, a first temperature and a second temperature of at least one monitoring point in each monitoring unit is obtained based on a set of optical fibers deployed on a battery surface in the monitoring unit, in which the set of optical fibers at least includes a first optical fiber configured to measure the first temperature of a battery body, and a second optical fiber coated with a hydrogen sensitive material configured to measure the second temperature of a battery exterior.

A battery cluster, a battery module, or a battery cells may be divided into one monitoring unit. Each monitoring unit may include one or more battery clusters, one or more battery modules or one or more battery cells, which is not limited to this.

A surface of the second optical fiber is coated with the hydrogen sensitive material, such as a WO3/Pt hydrogen sensitive material. When the battery occurs the thermal runaway to release the hydrogen, the WO3/Pt hydrogen sensitive material reacts with the hydrogen to release heat, which causes the temperature of the second optical fiber to rise, such that a hydrogen concentration may be determined based on a measured temperature of the second optical fiber. When a WO3/Pt is taken as the hydrogen sensitive material, a WO3 with a property similar to SiO2 may be sputtered on a surface of optical fiber as a base layer, then the WO3/Pt may be sputtered as the hydrogen sensitive layer at the same time, and finally a 5 nm Pt may be sputtered as a protective layer, which may inhibit a deterioration of the hydrogen sensitive material.

In embodiments of the disclosure, because a length of the optical fiber is tens of kilometers and may be bent at will. Therefore, the optical fiber may be twined on the battery surface in each monitoring unit, and a point at an interval with a preset length of the optical fiber may be taken as a monitoring point, thus realizing monitoring on hydrogen and a temperature of a large-scale battery energy storage power station at a battery cluster level, a module level or a battery core level, and improving the monitoring reliability of battery energy storage power stations.

In embodiments of the disclosure, a light source emitter corresponding to the optical fiber may be controlled to emit a light, and the first temperature of each monitoring point may be determined based on any optical principle related to temperature measurement during the transmission of the light in the first optical fiber. Similarly, the second temperature of each monitoring point is determined based on any optical principle related to the temperature measurement during the transmission of the light through the second optical fiber.

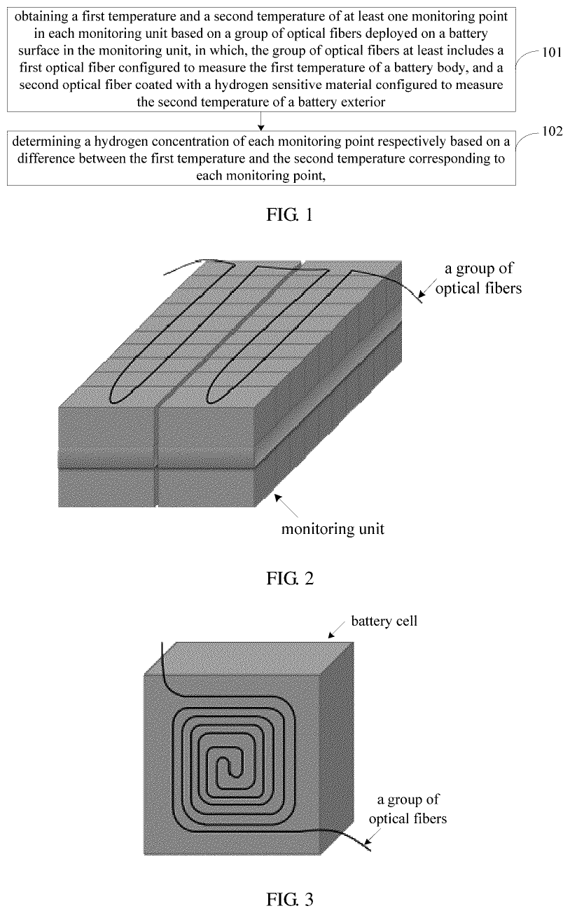

In addition, in order to improve the reliability of the composite monitoring on the hydrogen and the temperature of the battery energy storage power station, the optical fiber may be bent and arranged on a battery in the monitoring unit for multiple circles, to increase the monitoring point in a single monitoring unit, thus realizing monitoring the temperature and the hydrogen concentration in different positions in the single monitoring unit. As illustrated in FIG. 2, the optical fiber is bent and arranged for two circles on the battery in the monitoring unit.

In some embodiments, the optical fiber may be bent and twined on a single battery cell, as illustrated in FIG. 3, to realize monitoring temperatures and hydrogen concentrations at different positions in the single battery cell and improve the accuracy and reliability of monitoring the temperature and the hydrogen concentration.

It may be understood that, due to a fast transmission velocity of the light in the optical fiber, the temperature and the hydrogen concentration of each monitoring point may be obtained in real time within a preset time interval, which is also beneficial to improve the timeliness of monitoring the hydrogen and the temperature in the battery energy storage power station.

At block 102, a hydrogen concentration of each monitoring point is respectively determined based on a difference between the first temperature and the second temperature corresponding to the monitoring point.

In embodiments of the disclosure, the difference between the first temperature and the second temperature corresponding to each monitoring point is a temperature difference generated by the reaction between the hydrogen and the hydrogen sensitive material on the surface of the second optical fiber. Temperature increments of the second optical fiber in different hydrogen concentrations may be pre-tested, and the temperature increments of the second optical fiber in different hydrogen concentrations may be fitted to establish a correlation function between the hydrogen concentration and the temperature increments. Then, the hydrogen concentration of each monitoring point may be determined based on the difference between the first temperature and the second temperature corresponding to each monitoring point and the correlation function.

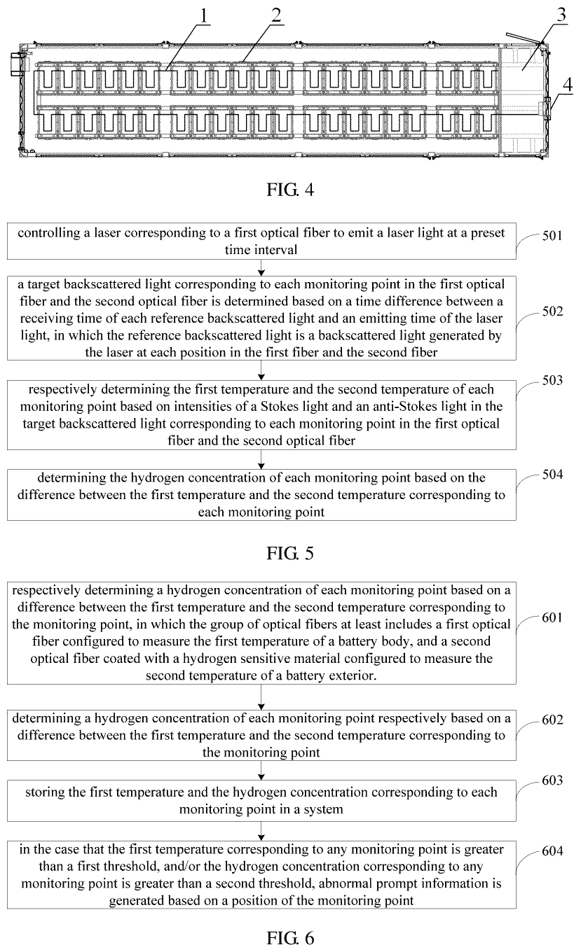

In some embodiments, monitoring a temperature and a hydrogen concentration of a battery prefabricated cabin may be completed by employing one group of optical fibers with a sufficient length. As illustrated in FIG. 4, multiple battery clusters 2 are regularly arranged in the battery prefabrication cabin, in which the battery cluster includes multiple battery modules, and each battery module may include multiple battery cells. A group of optical fibers 1 for monitoring the temperature and the hydrogen are bent and arranged in a circle on each battery cluster, and each battery cluster is taken as an independent unit for the temperature and hydrogen concentration monitoring. Sensing optical fibers pass through a fire cabinet 3 and are finally collected in a monitoring device 4. Thus, monitoring the temperature and released hydrogen of the battery in the battery prefabricated cabin may be implemented only by employing one group of optical fibers. Therefore, the monitoring device may be configured with multiple interfaces, each interface is connected with one group of optical fibers, and each group of optical fibers is configured for monitoring one battery prefabricated cabin. In this way, it is realized that the temperature and the hydrogen concentration of multiple distributed battery prefabricated cabins are monitored, the efficiency of the composite monitoring on the hydrogen and the temperature of the battery energy storage power station is improved, and the complexity of deploying the monitoring device is reduced.

In embodiments of the disclosure, the first temperature and the second temperature of at least one monitoring point in each monitoring unit are obtained based on one group of optical fibers deployed on the battery surface in each monitoring unit, and the hydrogen concentration of each monitoring point is determined based on the difference between the first temperature and the second temperature corresponding to each monitoring point. Thus, fine-grained monitoring on the temperature and the hydrogen concentration of the battery energy storage power station is realized, the accuracy and timeliness of the temperature and the hydrogen are improved, and the cost and deployment difficulty of monitoring the temperature and the hydrogen of the large-scale battery energy storage power station are reduced.

FIG. 5 is a flow chart illustrating a method for composite monitoring on hydrogen and a temperature of a battery energy storage power station according to an embodiment of the disclosure.

As illustrated in FIG. 5, the method for composite monitoring on the hydrogen and the temperature of the battery energy storage power station includes actions at blocks 501 to 504

At block 501, a laser corresponding to a first optical fiber is controlled to emit a laser light at a preset time interval.

In embodiments of the disclosure, a monitoring device may include a laser. The monitoring device may control the laser to emit the laser light at the preset time interval, to monitor the hydrogen and the temperature of the battery energy storage power station in real time.

At block 502, a target backscattered light corresponding to each monitoring point in the first optical fiber and the second optical fiber is determined based on a time difference between a receiving time of each reference backscattered light and an emitting time of the laser light, in which the reference backscattered light is a backscattered light generated by the laser at each position in the first fiber and the second fiber.

In embodiments of the disclosure, when the laser is transmitted in the optical fiber, Raman scattering may occur at all positions of the optical fiber, to generate a backscattered light. Since a light transmission requires time, returned time lengths of backscattered light at different positions are different. Therefore, a position where the Raman scattering occurs, corresponding to each reference backscattered light in the first optical fiber may be determined based on the time difference between the receiving time of each reference backscattered light in the first optical fiber and the emitting time of the laser light and a propagation velocity of the laser in the first optical fiber. Then, the target backscattered light corresponding to each monitoring point in the first optical fiber is determined by matching the position of each monitoring point with the position where the Raman scattering occurs corresponding to each reference backscattered light in the first optical fiber. Based on the same reason, a target backscattered light corresponding to each monitoring point in the second optical fiber may be determined. The reference backscattered light may be detected and determined by a wavelength division multiplexer in the monitoring device.

At block 503, the first temperature and the second temperature of each monitoring point are respectively determined based on intensities of a Stokes light and an anti-Stokes light in the target backscattered light corresponding to each monitoring point in the first optical fiber and the second optical fiber.

In embodiments of the disclosure, the intensities of the Stokes light and the anti-Stokes light in each target backscattered light may be determined by a photodetector in the monitoring device. Then, the first temperature of each monitoring point is calculated based on the intensity of the Stokes light and the intensity of the anti-Stokes light corresponding to each monitoring point in the first optical fiber; and the second temperature of each monitoring point is calculated based on the intensity of the Stokes light and the intensity of the anti-Stokes light corresponding to each monitoring point in the second optical fiber.

In some embodiments, a scattering position corresponding to each reference backscattered light is determined based on the time difference between the receiving time of each reference backscattered light in the first optical fiber and the emitting time of the laser light, then a first temperature of the scattering position corresponding to each reference backscattered light in the first optical fiber respectively is determined based on the intensity of the Stokes light and the intensity of the anti-Stokes light in each reference backscattered light. Then, an average value of the first temperature at each scattering position within a monitoring interval corresponding to each monitoring point is determined as the first temperature of each monitoring point. Based on the same reason, a scattering position corresponding to each reference backscattered light in the second optical fiber and the second temperature corresponding to each scattering position may be determined, and an average value of the second temperature at each scattering position in the monitoring interval corresponding to each monitoring point may be determined as the second temperature of each monitoring point. Thus, the accuracy of determining the first temperature and the second temperature may be improved, and the accuracy of the hydrogen and temperature monitoring of the battery energy storage power station may be further improved.

At block 504, the hydrogen concentration of each monitoring point is determined based on the difference between the first temperature and the second temperature corresponding to each monitoring point.

In embodiments of the disclosure, the detailed implementation process of the action at block 504 may be referred in the detailed description of any embodiment of the disclosure, which is not elaborated here.

In embodiments of the disclosure, after the laser corresponding to the first optical fiber is controlled to emit the laser light at the preset time interval, the target backscattered light corresponding to each monitoring point in the first optical fiber and the second optical fiber may be determined based on the time difference between the receiving time of the reference backscattered light and the emitting time of the laser light, and then the first temperature and the second temperature of each monitoring point may be determined respectively based on the intensities of the Stokes light and the anti-Stokes light in the target backscattered light corresponding to each monitoring point in the first optical fiber and the second optical fiber. Then, the hydrogen concentration of each monitoring point is respectively determined based on the difference between the first temperature and the second temperature corresponding to each monitoring point. Thus, the fine-grained monitoring on the temperature and hydrogen concentration of the battery energy storage power station is realized, the accuracy and timeliness of monitoring the temperature and the hydrogen are improved, and the cost and deployment difficulty of monitoring the temperature and the hydrogen of a large-scale battery energy storage power station are reduced.

FIG. 6 is a flow chart illustrating a method for composite monitoring on hydrogen and a temperature of a battery energy storage power station according to embodiment of the disclosure.

As illustrated in FIG. 6, the method for the composite monitoring on the hydrogen and the temperature of the battery energy storage power station includes actions at blocks 601 to 604

At block 601, a first temperature and a second temperature of at least one monitoring point in each monitoring unit are obtained based on a group of optical fibers deployed on a battery surface in the monitoring unit, in which the group of optical fibers at least includes a first optical fiber configured to measure the first temperature of a battery body, and a second optical fiber coated with a hydrogen sensitive material configured to measure the second temperature of a battery exterior.

At block 601, a hydrogen concentration of each monitoring point is respectively determined based on a difference between the first temperature and the second temperature corresponding to the monitoring point, in which the group of optical fibers at least includes a first optical fiber configured to measure the first temperature of a battery body, and a second optical fiber coated with a hydrogen sensitive material configured to measure the second temperature of a battery exterior.

At block 602, a hydrogen concentration of each monitoring point respectively is determined based on a difference between the first temperature and the second temperature corresponding to the monitoring point.

In embodiments of the disclosure, the detailed implementation process of the actions at blocks 601 to 602 may be referred to the detailed description of any embodiment of the disclosure, which is not elaborated here.

At block 603, the first temperature and the hydrogen concentration corresponding to each monitoring point is stored in a system.

In embodiments of the disclosure, the first temperature and the hydrogen concentration corresponding to each monitoring point may be stored in the system, to facilitate the traceability of the first temperature and the hydrogen concentration of each monitoring point.

In some embodiments, a monitoring device may also send the first temperature and the hydrogen concentration corresponding to each monitoring point to a composite monitoring system for the hydrogen and the temperature of the battery energy storage power station in real time. The monitoring system may visually present the first temperature and the hydrogen concentration corresponding to each monitoring point.

At block 604, in the case that the first temperature corresponding to any monitoring point is greater than a first threshold, and/or the hydrogen concentration corresponding to any monitoring point is greater than a second threshold, abnormal prompt information is generated based on a position of the monitoring point.

In embodiments of the disclosure, when the first temperature is greater than the first threshold, it indicates that the first temperature is too high, and there is a greater possibility that the thermal runaway of the battery occurs. When the hydrogen concentration is greater than the second threshold, it indicates that the thermal control of the battery may occur. Therefore, when the first temperature corresponding to any monitoring point is greater than the first threshold, and/or the hydrogen concentration corresponding to any monitoring point is greater than the second threshold, the abnormal prompt information including the position of the monitoring point may be generated, such that a safety officer may quickly determine the battery with the risk of thermal runaway and make countermeasures timely to deal with the risk of the thermal runaway. In some embodiments, a monitoring model for predicting a first temperature and a hydrogen concentration of each monitoring point in a following period may be trained based on a first temperature and a hydrogen concentration monitored in a historical period corresponding to each monitoring point. Then, a predicted temperature and a predicted hydrogen concentration of each monitoring point at a following time point may be determined based on the monitoring model and a first temperature and a hydrogen concentration corresponding to each monitoring point at a current time point, to realize early warning of the thermal runaway of the battery.

In some embodiments, the safety officer may trigger a confirmation button corresponding to the abnormal prompt information by a display interface of the monitoring device after determining that the thermal runaway occurs or will occur at the monitoring point indicated by the abnormal prompt information. Then, the monitoring device may receive a confirmation message of the abnormal prompt information and start an abnormal handling program, to deal with the risk of the thermal runaway of the battery in time and reduce the loss caused by the thermal runaway of the battery.

In some embodiments, if the battery time is too long, the characteristics of the battery may change. For example, if the battery is used for a long time and the battery ages, a temperature that causes the thermal runaway of the battery may drop. Therefore, the first threshold may be updated by a maximum value of the first temperature of each monitoring point within the preset time period without abnormality. Thus, the reliability of the composite monitoring on the hydrogen and temperature of the battery energy storage power station is improved.

In embodiments of the disclosure, after the first temperature and the second temperature of the at least one monitoring point in each monitoring unit are obtained based on the group of optical fibers deployed on the battery surface in each monitoring unit, the hydrogen concentration of each monitoring point is determined based on the difference between the first temperature and the second temperature corresponding to each monitoring point, and then, the first temperature and the hydrogen concentration corresponding to each monitoring point are stored in the system in a time order. In this case that the first temperature corresponding to any monitoring point is greater than a first threshold, and/or the hydrogen concentration corresponding to any monitoring point is greater than a second threshold, the abnormal prompt information is generated based on the position of the monitoring point Thus, the accuracy and timeliness of the temperature and the hydrogen are improved, and at the same time, the reliability of the composite monitoring on the hydrogen and the temperature of the battery energy storage power station is improved.

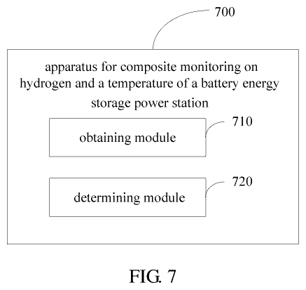

To realize the above embodiments, embodiments of the disclosure also provide an apparatus for composite monitoring on hydrogen and temperature of a battery energy storage power station. FIG. 7 is a block diagram illustrating an apparatus for composite monitoring on hydrogen and a temperature of a battery energy storage power station according to an embodiment of the disclosure.

As illustrated in FIG. 7, the apparatus 700 for the composite monitoring on the hydrogen and the temperature of the battery energy storage power station includes an obtaining module 710 and a determining module 720.

The obtaining module 710 is configured to obtain a first temperature and a second temperature of at least one monitoring point in each monitoring unit based on a group of optical fibers deployed on a battery surface in the monitoring unit, in which the group of optical fibers at least includes a first optical fiber configured to measure the first temperature of a battery body, and a second optical fiber coated with a hydrogen sensitive material configured to measure the second temperature of a battery exterior.

The determining module 720 is configured to determine a hydrogen concentration of each monitoring point respectively based on a difference between the first temperature and the second temperature corresponding to the monitoring point.

In a possible implementation of embodiments of the disclosure, the obtaining module 710 is configured to:
control a laser corresponding to the group of optical fibers to emit a laser light at a preset time interval;
determine a target backscattered light corresponding to each monitoring point in the first optical fiber and the second optical fiber based on a time difference between a receiving time of each reference backscattered light and an emitting time of the laser light, in which the reference backscattered light is a backscattered light generated by the laser at each position in the first fiber and the second fiber; and
determine the first temperature and the second temperature of each monitoring point respectively based on intensities of a Stokes light and an anti-Stokes light in the target backscattered light corresponding to each monitoring point in the first optical fiber and the second optical fiber.

In a possible implementation of embodiments of the disclosure, the apparatus also includes an abnormal handling module, configured to:
store the first temperature and the hydrogen concentration corresponding to each monitoring point in a system; and
in the case that the first temperature corresponding to any monitoring point is greater than a first threshold, and/or the hydrogen concentration corresponding to any monitoring point is greater than a second threshold, generate abnormal prompt information based on a position of the monitoring point.

In a possible implementation of embodiments of the disclosure, the abnormal handling module is also configured to:
in the case that confirmation information of the abnormal prompt information is received, initiate an abnormal handling program.

In a possible implementation of embodiments of the disclosure, the apparatus also includes:
an updating module, configured to update the first threshold using a maximum value of the first temperature in the case that no abnormal condition exists at each monitoring point within a preset time period.

It should be noted that, the above description for embodiments of the method for the composite monitoring on the hydrogen and the temperature of the battery energy storage power station is also applicable to the apparatus for the composite monitoring on the hydrogen and the temperature of the battery energy storage power station of this embodiment, which is not elaborated herein.

In embodiments of the disclosure, the first temperature and the second temperature of the at least one monitoring point in each monitoring unit are obtained based on the group of optical fibers deployed on the battery surface in each monitoring unit, and the hydrogen concentration of each monitoring point is determined based on the difference between the first temperature and the second temperature corresponding to each monitoring point. Thus, the fine-grained monitoring on the temperature and the hydrogen concentration of the battery energy storage power station is realized, the accuracy and timeliness of the temperature and the hydrogen are improved, and the cost and deployment difficulty of monitoring the temperature and the hydrogen of a large-scale battery energy storage power station are reduced.

In order to realize the above embodiments, embodiments of the disclosure also provide a computer device, including a processor and a memory storing program codes executable by the processor.

The processor is configured to read the program codes to run a program corresponding to the program codes, to implement the method for the composite monitoring on the hydrogen and the temperature of the battery energy storage power station in the above embodiments.

In order to realize the above embodiments, embodiments of the disclosure also provide a computer-readable storage medium for storing a computer program. The computer program is executed by a processor, to implement the method for the composite monitoring on the hydrogen and the temperature of the battery energy storage power station in the above embodiments.

In order to realize the above embodiments, embodiments of the disclosure also provide a computer program product storing a computer program. The computer program is executed by a processor to implement the method for the composite monitoring on the hydrogen and the temperature of the battery energy storage power station in the above embodiments.

In order to realize the above embodiments, embodiment of the disclosure also provides a computer program including computer program codes. When the computer program codes are run on a computer, the computer is enabled to execute the method for the composite monitoring on the hydrogen and the temperature of the battery energy storage power station in the above embodiments.

Although embodiments of the disclosure are illustrated and described above, it may be understood that the above embodiments are exemplary and may not be understood as limitations of the disclosure. Those skilled in the art may make changes, modifications, substitutions and variations to the above embodiments within the scope of the disclosure.

All embodiments of the disclosure may be executed alone or in combination with other embodiments, which are regarded as the protection scope of the disclosure.

1. A method for composite monitoring on hydrogen and a temperature of a battery energy storage power station, comprising:
obtaining a first temperature and a second temperature of at least one monitoring point in each monitoring unit based on a group of optical fibers deployed on a battery surface in the monitoring unit, wherein the group of optical fibers at least comprises a first optical fiber configured to measure the first temperature of a battery body, and a second optical fiber coated with a hydrogen sensitive material configured to measure the second temperature of a battery exterior; and
determining a hydrogen concentration of each monitoring point respectively based on a difference between the first temperature and the second temperature corresponding to the monitoring point, wherein temperature increments of the second optical fiber at different hydrogen concentrations are pre-tested, a correlation function between the hydrogen concentration and the temperature increment is established by fitting the temperature increments of the second optical fiber at different hydrogen concentrations, and the hydrogen concentration at each monitoring point is determined based on the difference between the first temperature and the second temperature corresponding to each monitoring point and the correlation function;
wherein obtaining the first temperature and the second temperature of the at least one monitoring point in each monitoring unit based on the group of optical fibers deployed on the battery surface in the monitoring unit includes
controlling a laser corresponding to the group of optical fibers to emit a laser light at a preset time interval;
determining a target backscattered light corresponding to each monitoring point in the first optical fiber and the second optical fiber based on a time difference between a receiving time of each reference backscattered light and an emitting time of the laser light, wherein the reference backscattered light is a backscattered light generated by the laser at each position in the first fiber and the second fiber; and
determining the first temperature and the second temperature of each monitoring point respectively based on intensities of a Stokes light and an anti-Stokes light in the target backscattered light corresponding to each monitoring point in the first optical fiber and the second optical fiber;
wherein determining the target backscattered light corresponding to each monitoring point in the first optical fiber and the second optical fiber based on the time difference between the receiving time of each reference backscattered light and the emitting time of the laser light includes
determining a position where Raman scattering occurs, corresponding to each reference backscattered light in the first optical fiber based on the time difference between the receiving time of each reference backscattered light in the first optical fiber and the emitting time of the laser light and a propagation speed of the laser in the first optical fiber, and determining the target backscattered light corresponding to each monitoring point in the first optical fiber by matching the position of each monitoring point with the position where the Raman scattering occurs corresponding to each reference backscattered light in the first optical fiber;
wherein determining the first temperature of each monitoring point respectively based on the intensity of the Stokes light and the anti-Stokes light in the target backscattered light corresponding to each monitoring point in the first optical fiber and the second optical fiber includes
determining a scattering position corresponding to each reference backscattered light based on the time difference between the receiving time of each reference backscattered light in the first optical fiber and the emitting time of the laser light, determining a first temperature of the scattering position corresponding to each reference backscattered light in the first optical fiber respectively based on the intensity of the Stokes light and the intensity of the anti-Stokes light in each reference backscattered light, and determining an average value of the first temperature at each scattering position within a monitoring interval corresponding to each monitoring point as the first temperature of each monitoring point.

2. The method of claim 1, further comprising:
storing the first temperature and the hydrogen concentration corresponding to each monitoring point in a system; and
in the case that at least one condition where the first temperature corresponding to any monitoring point is greater than a first threshold or the hydrogen concentration corresponding to any monitoring point is greater than a second threshold is met, generating abnormal prompt information based on a position of the monitoring point.

3. The method of claim 2, further comprising:
in the case that confirmation information of the abnormal prompt information is received, initiating an abnormal handling program.

4. The method of claim 2, further comprising:
updating the first threshold using a maximum value of the first temperature in the case that no abnormal condition exists at each monitoring point within a preset time period.

5. An electronic device, comprising:
a processor; and
a memory, configured to store instructions executable by the processor,
wherein the processor is configured to;
obtain a first temperature and a second temperature of at least one monitoring point in each monitoring unit based on a group of optical fibers deployed on a battery surface in the monitoring unit, wherein the group of optical fibers at least comprises a first optical fiber configured to measure the first temperature of a battery body, and a second optical fiber coated with a hydrogen sensitive material configured to measure the second temperature of a battery exterior; and
determine a hydrogen concentration of each monitoring point respectively based on a difference between the first temperature and the second temperature corresponding to the monitoring point, wherein temperature increments of the second optical fiber at different hydrogen concentrations are pre-tested, a correlation function between the hydrogen concentration and the temperature increment is established by fitting the temperature increments of the second optical fiber at different hydrogen concentrations, and the hydrogen concentration at each monitoring point is determined based on the difference between the first temperature and the second temperature corresponding to each monitoring point and the correlation function;
control a laser corresponding to the group of optical fibers to emit a laser light at a preset time interval;
determine a target backscattered light corresponding to each monitoring point in the first optical fiber and the second optical fiber based on a time difference between a receiving time of each reference backscattered light and an emitting time of the laser light, wherein the reference backscattered light is a backscattered light generated by the laser at each position in the first fiber and the second fiber; and
determine the first temperature and the second temperature of each monitoring point respectively based on intensities of a Stokes light and an anti-Stokes light in the target backscattered light corresponding to each monitoring point in the first optical fiber and the second optical fiber;
wherein determining a target backscattered light corresponding to each monitoring point in the first optical fiber and the second optical fiber based on the time difference between the receiving time of each reference backscattered light and the emitting time of the laser light includes;
determining a position where Raman scattering occurs, corresponding to each reference backscattered light in the first optical fiber based on the time difference between the receiving time of each reference backscattered light in the first optical fiber and the emitting time of the laser light and a propagation speed of the laser in the first optical fiber, and determining the target backscattered light corresponding to each monitoring point in the first optical fiber by matching the position of each monitoring point with the position where the Raman scattering occurs, corresponding to each reference backscattered light in the first optical fiber;
wherein determining the first temperature of each monitoring point respectively based on the intensity of the Stokes light and the intensity of the anti-Stokes light in the target backscattered light corresponding to each monitoring point in the first optical fiber and the second optical fiber includes;
determining a scattering position corresponding to each reference backscattered light based on the time difference between the receiving time of each reference backscattered light in the first optical fiber and the emitting time of the laser light, determining a first temperature of the scattering position corresponding to each reference backscattered light in the first optical fiber respectively based on the intensity of the Stokes light and the intensity of the anti-Stokes light in each reference backscattered light, and determining an average value of the first temperature at each scattering position within a monitoring interval corresponding to each monitoring point as the first temperature of each monitoring point.

6. The electronic device of claim 5, wherein the processor is further configured to:
store the first temperature and the hydrogen concentration corresponding to each monitoring point in a system; and
in the case that at least one condition where the first temperature corresponding to any monitoring point is greater than a first threshold or the hydrogen concentration corresponding to any monitoring point is greater than a second threshold is met, generate abnormal prompt information based on a position of the monitoring point.

7. (canceled)

8. A non-transitory computer-readable storage medium for including a computer program, wherein a processor is configured to execute the computer program is executed to implement a method for composite monitoring on hydrogen and a temperature of a battery energy storage power station, comprising:
obtaining a first temperature and a second temperature of at least one monitoring point in each monitoring unit based on a group of optical fibers deployed on a battery surface in the monitoring unit, wherein the group of optical fibers at least includes a first optical fiber configured to measure the first temperature of a battery body, and a second optical fiber coated with a hydrogen sensitive material configured to measure the second temperature of a battery exterior; and
determining a hydrogen concentration of each monitoring point respectively based on a difference between the first temperature and the second temperature corresponding to the monitoring point, wherein temperature increments of the second optical fiber at different hydrogen concentrations are pre-tested, a correlation function between the hydrogen concentration and the temperature increment is established by fitting the temperature increments of the second optical fiber at different hydrogen concentrations, and the hydrogen concentration at each monitoring point is determined based on the difference between the first temperature and the second temperature corresponding to each monitoring point and the correlation function;
wherein obtaining the first temperature and the second temperature of the at least one monitoring point in each monitoring unit based on the group of optical fibers deployed on the battery surface in the monitoring unit includes;
controlling a laser corresponding to the group of optical fibers to emit a laser light at a preset time interval;
determining a target backscattered light corresponding to each monitoring point in the first optical fiber and the second optical fiber based on a time difference between a receiving time of each reference backscattered light and an emitting time of the laser light, wherein the reference backscattered light is a backscattered light generated by the laser at each position in the first fiber and the second fiber; and
determining the first temperature and the second temperature of each monitoring point respectively based on intensities of a Stokes light and an anti-Stokes light in the target backscattered light corresponding to each monitoring point in the first optical fiber and the second optical fiber;
wherein determining the target backscattered light corresponding to each monitoring point in the first optical fiber and the second optical fiber based on the time difference between the receiving time of each reference backscattered light and the emitting time of the laser light includes;
determining a position where Raman scattering occurs, corresponding to each reference backscattered light in the first optical fiber based on the time difference between the receiving time of each reference backscattered light in the first optical fiber and the emitting time of the laser light and a propagation speed of the laser in the first optical fiber, and determining the target backscattered light corresponding to each monitoring point in the first optical fiber by matching the position of each monitoring point with the position where the Raman scattering occurs corresponding to each reference backscattered light in the first optical fiber;
wherein determining the first temperature of each monitoring point respectively based on the intensity of the Stokes light and the anti-Stokes light in the target backscattered light corresponding to each monitoring point in the first optical fiber and the second optical fiber includes;
determining a scattering position corresponding to each reference backscattered light based on the time difference between the receiving time of each reference backscattered light in the first optical fiber and the emitting time of the laser light, determining a first temperature of the scattering position corresponding to each reference backscattered light in the first optical fiber respectively based on the intensity of the Stokes light and the intensity of the anti-Stokes light in each reference backscattered light, and determining an average value of the first temperature at each scattering position within a monitoring interval corresponding to each monitoring point as the first temperature of each monitoring point.

9. (canceled)

10. (canceled)

11. The electronic device of claim 6, wherein the processor is further configured to:
in the case that confirmation information of the abnormal prompt information is received, initiate an abnormal handling program.

12. The electronic device of claim 6, wherein the processor is further configured to:
update the first threshold using a maximum value of the first temperature in the case that no abnormal condition exists at each monitoring point within a preset time period.

13. The non-transitory computer-readable storage medium of claim 8, wherein the method further comprises:
storing the first temperature and the hydrogen concentration corresponding to each monitoring point in a system; and
in the case that at least one condition where the first temperature corresponding to any monitoring point is greater than a first threshold or the hydrogen concentration corresponding to any monitoring point is greater than a second threshold is met, generating abnormal prompt information based on a position of the monitoring point.

14. The non-transitory computer-readable storage medium of claim 12, wherein the method further comprises:
in the case that confirmation information of the abnormal prompt information is received, initiating an abnormal handling program.

15. The non-transitory computer-readable storage medium of claim 12, wherein the method further comprises:
updating the first threshold using a maximum value of the first temperature in the case that no abnormal condition exists at each monitoring point within a preset time period.
